(19) United States
(12) Patent Application Publication
(10) Pub. No.: US 2009/0213229 A1
(43) Pub. Date: Aug. 27, 2009

(54) Surveillance System

(75) Inventor: Marquis R. Coleman, Detroit, MI (US)

Correspondence Address: BROOKS KUSHMAN P.C., 1000 TOWN CENTER, TWENTY-SECOND FLOOR, SOUTHFIELD, MI, 48075, US

(73) Assignee: SecureCom Technologies, Inc., Detroit, MI (US)

(21) Appl. No.: 12/037,517

(22) Filed: Feb. 26, 2008

(51) Int. Cl. H04N 5/225; H04N 9/04

(52) U.S. Cl. 348/207.99; 348/E05.024

(57) ABSTRACT

A security system and method for operating same. The method includes; providing a surveillance system including a plurality of application specific integrated circuits that communicate with one another over a main system bus, wherein each of the plurality of application specific integrated circuits perform one or more predetermined functions within the surveillance system; establishing a decentralized communications network amongst the plurality of application specific integrated circuits within the surveillance system; determining that one or more of the application specific integrated circuits is not performing one or more of its predetermined functions; and utilizing one or more of the functioning application specific integrated circuits to perform the function of the non-functioning application specific integrated circuit. A surveillance system is also disclosed.

### TECHNICAL FIELD

The invention relates in general to a security system and a method for operating the same.

### BACKGROUND

Security systems are typically provided to enhance the security of a home, business or the like. Conventional security systems may, however, be intermittently inoperative due to attacks by perpetrators, or, alternatively, adverse conditions caused by weather, power outages, power surges or the simple failure of components of the security system. Thus, if a conventional security system becomes partially or fully inoperative, the security offered to the home/business owner may be compromised.

In view of the above drawbacks and for other reasons, a need exists in the art for an improved security system.

### BRIEF DESCRIPTION OF THE DRAWINGS

The disclosure will now be described, by way of example, with reference to the accompanying drawings, in which:

FIG. 1 is a plan view of a surveillance system in accordance with an exemplary embodiment of the invention;

FIG. 2 is a plan view of a plurality of networked surveillance systems that monitors one or more of a region, municipality and/or a plurality of locations in accordance with an exemplary embodiment of the invention;

FIG. 3 is a view of a portion of the surveillance system of FIG. 1 in accordance with an exemplary embodiment of the invention;

FIG. 4A illustrates a partial view of the surveillance system of FIG. 1 in an operational state in accordance with an exemplary embodiment of the invention;

FIG. 4B illustrates a partial view of the surveillance system of FIG. 1 in an operational state in accordance with an exemplary embodiment of the invention;

FIG. 5A illustrates a partial view of the surveillance system of FIG. 1 in an operational state in accordance with an exemplary embodiment of the invention; and

FIG. 5B illustrates a partial view of the surveillance system of FIG. 1 in an operational state in accordance with an exemplary embodiment of the invention.

### DETAILED DESCRIPTION

The Figures illustrate an exemplary embodiment of a security system in accordance with an embodiment of the invention. Based on the foregoing, it is to be generally understood that the nomenclature used herein is simply for convenience and the terms used to describe the invention should be given the broadest meaning by one of ordinary skill in the art.

A. System Overview

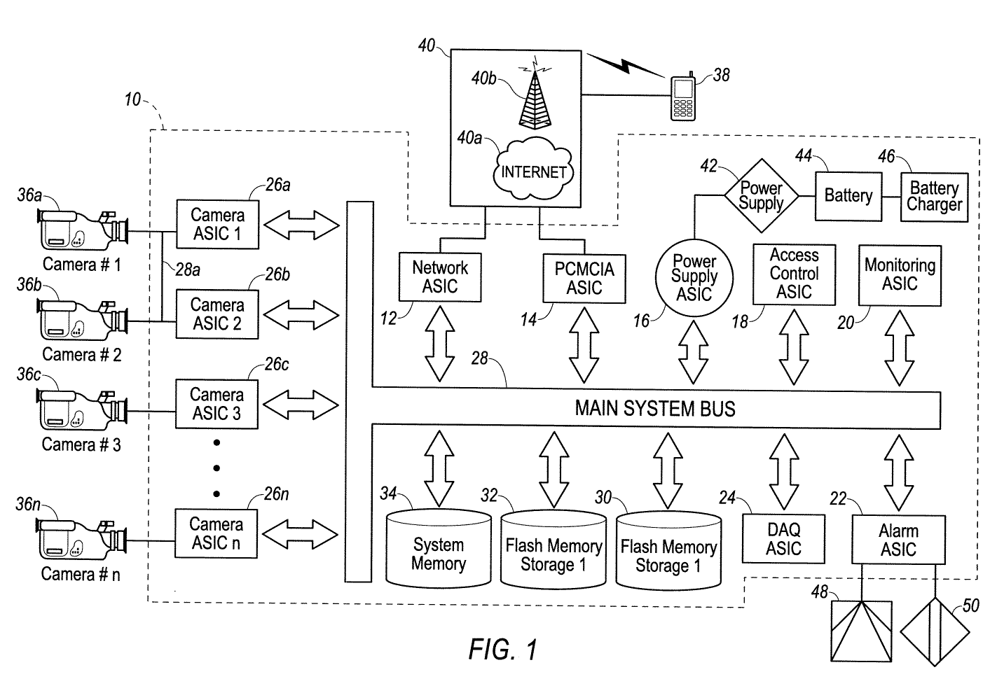

Referring to FIG. 1, a plan view of a surveillance system is shown generally at 10 according to an embodiment. The surveillance system 10 includes several decentralized application specific integrated circuits (ASICs), which are shown generally at 12-26n, that communicate with one another over a main system bus, which is shown generally at 28. Although bus 28 is depicted as a hard-wire bus, one skilled in the art will readily appreciate that communications between some or all ASIC's 12-26n could be accomplished partly, or entirely, by way of a wireless communications network.

In an embodiment, the bus 28 connecting the ASICs 12-26n may include a proprietary or industry-standard bus, such as, for example, an advanced microcontroller bus architecture (AMBA) bus from an advanced RISC machine (ARM). Functionally, the bus 28 is the backbone of the surveillance system 10 for permitting mesh routing of communications/data to/from the ASICs 12-26n.

In an embodiment, the ASICs shown generally at 12-26n may each be defined to provide one, or more unique functions for operating the surveillance system 10. For example, the ASICs 12-26n include, but are not limited to, the following: a Network ASIC 12, a Peripheral Component Micro-channel Interconnect Architecture (PCMCIA) ASIC 14, a Power Supply ASIC 16, an Access Control ASIC 18, a Monitoring ASIC 20, an Alarm ASIC 22, a Data Acquisition (DAQ) ASIC 24 and one or more Camera ASICs 26a-26n. The specific function of each of the ASICs 12-26n is described in the foregoing disclosure.

Network ASIC 12

In an embodiment, the Network ASIC 12 manages the streaming video and network connections (e.g., an Ethernet connection) to the Camera ASICs 26a-26n. Further, the Network ASIC 12 negotiates industry standard networking protocols such as, for example, transmission control protocol/Internet protocol (TCP/IP) in order to establish and maintain a connection with a user of the surveillance system 10.

PCMCIA ASIC 14

In an embodiment, the PCMCIA ASIC 14 allows connectivity to a service provider wireless card (e.g., an aircard). In an embodiment, the PCMCIA ASIC 14 allows the surveillance system 10 to be installed, for example, on a mobile vehicle or transportation system in order to provide video to the end user.

Power Supply ASIC 16

In an embodiment, the Power Supply ASIC 16 is shown connected to a power supply 42 that is “daisy-chained” (i.e., connected) to a battery 44 and a battery charger 46. In an embodiment, the Power Supply ASIC 16 maintains primary and/or secondary power throughout the surveillance system 10.

When in a “primary power mode” (e.g., AC power), such that the surveillance system 10 is operating from the power supply 42, the Power Supply ASIC 16 may monitor the available power from the supply 42. When, for example, the power supply 42 is drained, the Power Supply ASIC 16 may then cause the surveillance system 10 to operate on reserve power from the battery 44.

When in a “secondary power mode” (e.g., DC power), such that the surveillance system 10 is operating from the battery 44, the power supply ASIC 16 may monitor the available reserve power of the battery 44 and calculate an amount of time that the surveillance system 10 will be operable based upon its operating conditions. Should the power of the battery 44 be diminished to a predetermined amount, the Power Supply ASIC 16 may send a notification to automatically shut-down predetermined components and/or downstream power users in the surveillance system 10 in order to conserve power and prevent system-wide failure. Alternatively, rather than cutting off power in the surveillance system 10 as described above, the notification may be sent to a system operator by way of, for example, a cell phone, desktop computer, or the like such that the system operator may manually re-route and/or cut-off power to any suitable component within the surveillance system 10, as desired.

Access Control ASIC 18

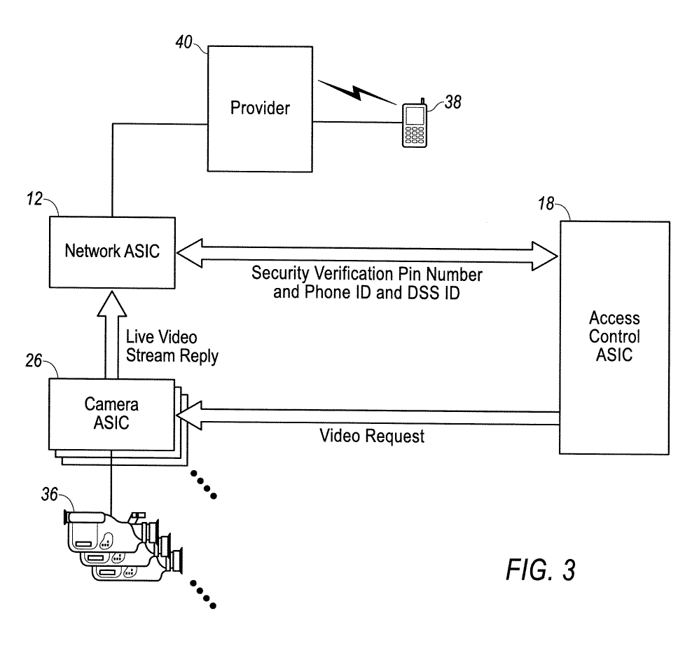

In an embodiment, the Access Control ASIC 18 provides security protocols for determining the authentication of the party that is requesting and/or accepting delivery of the video feed captured by one or more cameras 36a-36n. Functionality of the Access Control ASIC 18 is described in greater detail in FIG. 3.

Monitoring ASIC 20

Because it is perceivable that any one of the ASICs 12-26n may fail at any time for a variety of reasons, the surveillance system 10 may include a Monitoring ASIC 20 that provides a failure monitoring function. Alternatively, or, in addition to the Monitoring ASIC 20, firmware running in one or more of the ASICs 12-18, 22-26n may perform a self-monitoring function.

In the event that one of the ASICs 12-18, 22-26n fails, the monitoring function of the Monitoring ASIC 20 and/or the firmware automatically designates a supporting/complementing ASIC 12-18, 22-26n and re-routes the function of the failed ASIC 12-18, 22-26n to the designated ASIC 12-18, 22-26n.

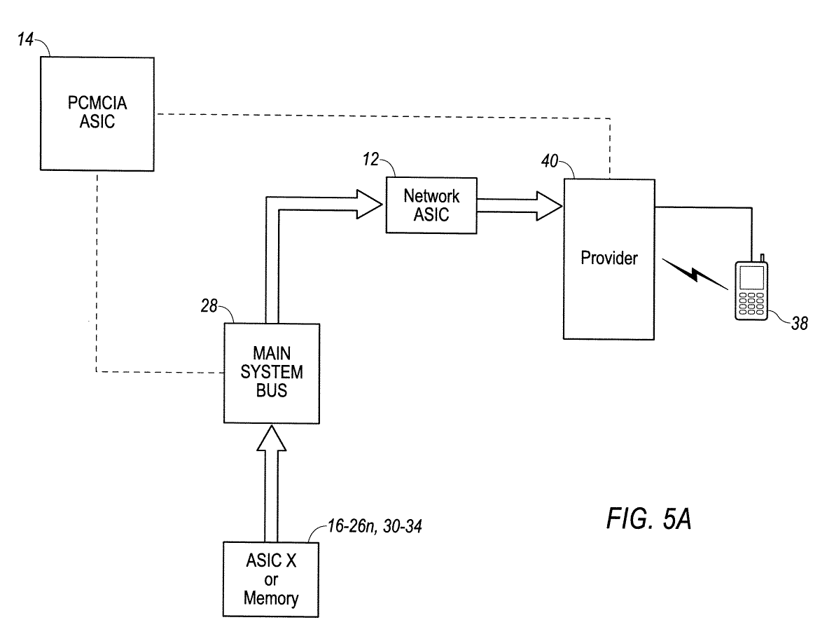

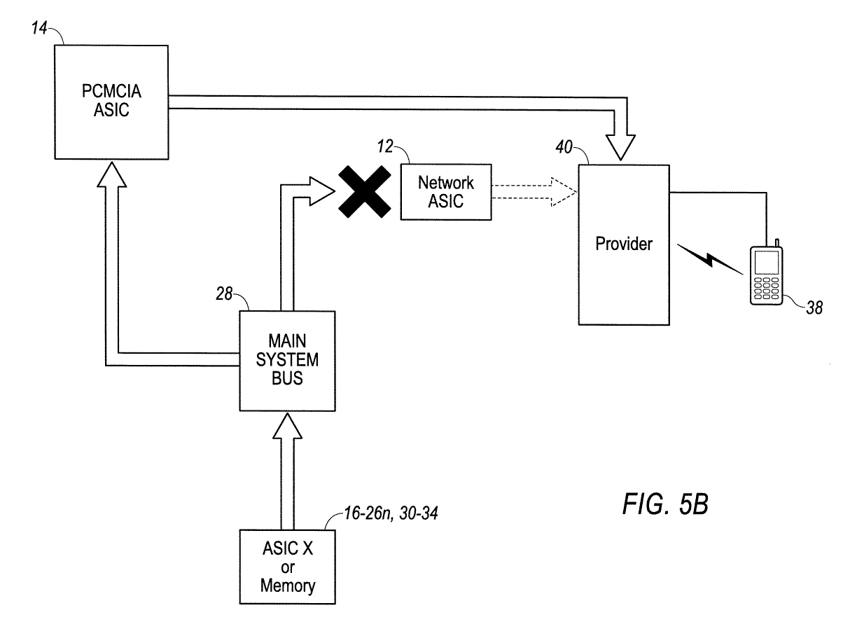

In addition to being able to identify an overall failure of an ASIC 12-18, 22-26n, the Monitoring ASIC 20 may determine, for example, a failure of an ASIC that is located downstream another ASIC; for example, if more of more of the ASICs 12-18, 22-24 downstream the Camera ASICs 26a-26n have failed, the Monitoring ASIC 20 may identify the best path for returning a requested video feed to an end user and re-route the requested video feed around the failed ASIC 12-18, 22-24 that is downstream the camera ASIC 26a-26n (see, e.g., FIG. 5B).

In another embodiment, if, for example, a fan of one of the ASICs 12-18, 22-26n fails, the Monitoring ASIC 20 may report the potential failure of one or more of the ASICs 12-18, 22-26n to a technician such that the technician may perform preventative maintenance on the surveillance system 10. Further, if, for example, a fan failure is detected as described above, the Monitoring ASIC 20 may temporarily shut-down the ASIC 12-18, 22-26n including the failed fan and re-route the functions of the ASIC with the failed fan to a complementing ASIC. Further, if a failed fan is detected, and, if one or more back-up fans are provided, the Monitoring ASIC 20 may activate the back-up fans.

If desired, the Monitoring ASIC 20 may include the following functions, or, alternatively, the following functions may be provided in client software that is stored in one of the ASICs 12-18, 22-26n, or, alternatively, in memory 30-34. In an embodiment, a “heartbeat” function may be provided that determines, for example, if a system-wide network outage has occurred. In an embodiment, the heartbeat monitor may query each component of the surveillance system 10, for example, once every thirty seconds. Further, in an embodiment, a troubleshooting function may be provided that communicates system states or malfunctions (e.g., a fan failure described above) to an end user and/or technician.

Alarm ASIC 22

The Alarm ASIC 22 may communicate with a motion detector 48 and/or proximity sensor 50, and, in the event that one or more of the motion detector 48 and/or proximity sensor 50 detects a potential security situation, the Alarm ASIC 22 may communicate with the DAQ ASIC 24 as described in the foregoing disclosure.

DAQ ASIC 24

In an embodiment, the DAQ ASIC 24 communicates with the Alarm ASIC 22 to alert an end user regarding event information pertaining to the surveillance system 10. In the event that one or more of the motion detector 48 and/or proximity sensor 50 detects a potential security situation, the Alarm ASIC 22 may, for example, collect and send analog data to the DAQ ASIC 24 to cause the DAQ ASIC 24 to send binary output(s) in the form of a notification to the end user such that the end user may be notified of the situation, and, in response to the received notification, the user may selectively obtain a video feed from the surveillance system 10 as described in the foregoing disclosure. In an embodiment, the notification sent to the user may include, for example, an email and/or text message, which may be received and displayed on an image displaying device 38, that says, for example “POTENTIAL SECURITY SITUATION HAS BEEN DETECTED, REQUEST LIVE VIDEO FEED?”

Camera ASIC 26

In an embodiment, the Camera ASICs 26a-26n perform several functions. For example, the Camera ASICs 26a-26n (a) capture live streaming video from cameras, which are shown generally at 36a-36n, (b) encode the captured video to a format designed for mobile imaging device networks and (c) deliver the encoded video at a predetermined time, or, alternatively, upon request. In an embodiment, the video may be delivered to one or more of the memory devices, which are shown generally at 30-34, and/or an image displaying device, which is shown generally at 38. In an embodiment, each camera 36a-36n corresponds to a dedicated camera ASIC 26a-26n.

Functionally, when a camera ASIC 26a-26n initializes, the camera ASIC 26a-26n determines whether or not the video feed should be encrypted/encoded. The encoding capabilities may be provided either in firmware, flash memory storage, or the like. After initialization of the camera ASIC 26a-26n is complete, the camera ASIC 26a-26n determines when recording should commence in reference to a request and/or predetermined date and/or time.

Memory Devices 30-34

Memory devices are shown generally at 30-34. Each memory device 30-34 may be a discrete component, or, alternatively, each ASIC 12-26n may include a dedicated memory device.

In an embodiment, the memory devices 30-34 may include, for example, one or more flash memory devices 30, 32 and a system memory device 34. It will be appreciated that the surveillance system 10 may include software that is stored, for example, in one or more of the memory devices 30-34 that performs various functions for operating the surveillance system 10.

In an embodiment, flash memory devices 30, 32 may include, for example, an industry standard storage device such as an integrated drive electronics (IDE) hard drive or a USB drive. In another embodiment, the flash memory device 30, 32 may include, for example, a CompactFlash device. Functionally, the flash memory device 30, 32 may store encoded video of any or all cameras 36a-36n for later viewing as well as any software for any or all ASICs 12-26n in the system.

In an embodiment, the system memory device 34 may include any type of random access memory (RAM). In an embodiment, the system memory device 34 may function as a “scratchpad” for temporarily storing information used by any or all of the ASICs 12-26n while the surveillance system 10 is running during a partial or system-wide power failure. Further, the system memory device 34 may run any program(s) loaded from the flash memory devices 30, 32. Although the system memory device 34 is shown connected to the main system bus 28, it will be appreciated that memory devices similar to the system memory device 34 may be discretely and directly connected to any desirable ASICs 12-26n.

B. Network Overview

The surveillance system 10 may include, or, alternatively, interface with several image capturing devices, which is/are shown generally at 36a-36n. In an embodiment, the one or more image capturing devices 36a-36n may include, for example, cameras. In an embodiment, the one or more cameras 36a-36n may include, for example, charge-couple device (CCD) cameras. Although one or more CCD cameras 36a-36n is/are discussed above, it will be appreciated that the invention is not limited to one or more CCD cameras 36a-36n and that any suitable imaging device may be included or associated with the surveillance system 10, as desired.

Further, the surveillance system 10 may include, or, alternatively, interface with one or more image displaying devices, which is/are shown generally at 38. In an embodiment, the one or more image displaying devices 38 may include, for example, a mobile device, including, for example, a cell phone, a personal digital assistant (PDA), or the like. Alternatively, the one or more image displaying devices 38 may include, for example, an immobile device, including, for example, a desktop computer terminal. Although cell phones, PDAs and desktop computer terminals are discussed above, it will be appreciated that the invention is not limited to the above image displaying devices 38 and that any suitable image displaying device 38 may be included, as desired.

In an embodiment, the image displaying device 38 may communicate, for example, over a wired or wireless connection, with the one or more of the ASICs 12-26n by way of, for example, a provider 40, such as, for example an Internet Service Provider (ISP), or, alternatively, a phone service provider. The provider 40, accordingly, may own, operate and/or provide access to/from one or more of the Internet, which is represented generally at 40a, and plain-old telephone services (POTS) and/or cellular phone services, which is/are represented generally at 40b. It will be appreciated that the communication between the image displaying device 38 and the one or more ASICs 12-26n is not limited according to the types of providers 40a, 40b listed above and that any suitable provider 40 that owns, operates and/or provides access to/from any type of communication system/methodology may be employed, as desired.

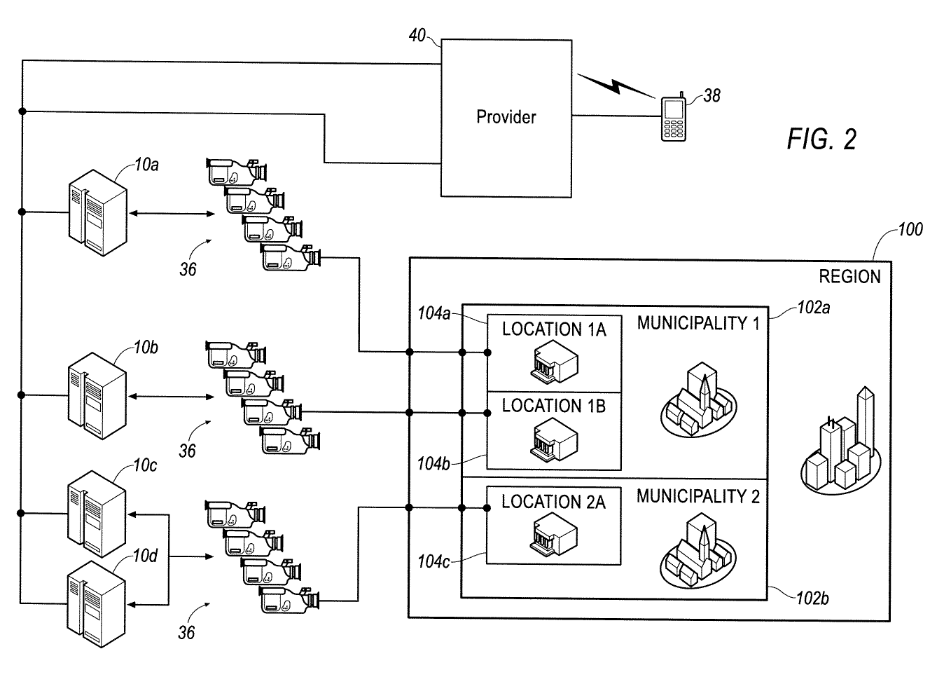

Referring to FIG. 2, it will be appreciated that a user may utilize the image displaying device 38 to receive a video feed/and/or still/streaming images from the one or more cameras 36 that may, for example, be positioned throughout a region, which is shown generally at 100. Further, by reference to FIGS. 1 and 2, for example, it will be appreciated that the images are provided to the image displaying device 38 by way of the provider 40 and one or more networked surveillance systems, which are shown generally at 10a-10d.

Accordingly, if, for example, the user operating the image displaying device 38 is an agent of a security firm, the firm may contract security services for a large number of metropolitan areas 100 for many cities spread across the country, or, alternatively, the world. However, it will be appreciated that a security firm may, for example, monitor a relatively smaller area, such as, for example, a municipality 102a, 102b or one or more locations 104a-104c within a municipality 102a, 102b.

If, for example, the user employs many cameras 36 spread throughout a plurality of regions 100, the user may locate and select images from a specific camera by first selecting a region 100, then subsequently selecting a municipality 102a, 102b within the region 100, and then selecting a specific location 104a-104c within the municipality 102a, 102b. Once the specific location 104a-104c is selected, the user may select a camera 36a-36n from a directory of cameras 36 such that a particular video feed from a plurality of video feeds may be viewed for further scrutiny. It will be appreciated, however, that if the user of the surveillance system 10 is a home or business owner, a default location 104a-104c may be displayed on the image displaying device 38 upon requesting/viewing video feed(s) from one or more cameras 36 rather than drilling down to a specific location 104a-104c of a region 100.

C. User Verification & Video Request

Referring to FIGS. 1 and 3, initial connection of the image displaying device 38 to the surveillance system 10 is permitted by the Network ASIC 12 or its complement. Once the connection is established, the Network ASIC 12 turns control of the session over to the Access Control ASIC 18 or its complement for requesting and accessing a video feed from one or more of the cameras 36.

However, prior to accessing video from the one or more cameras 36a-36n from the directory of cameras 36, the video feed requesting party at the image displaying device 38 may be authenticated and verified. For example, a session may begin by starting the client software, which may be stored remotely on a component of the surveillance system 10 or locally on the image displaying device 38. Next, an instruction is sent to the requesting party at the image displaying device 38, which may include, for example, a request for a key or personal identification number (PIN) from the user. Upon verification of the key or PIN at one or more of the Access Control ASIC 18 and/or memory 30-34, a “handshake” between the user and the surveillance system 10 is executed such that the user is granted access to the video feed(s). It will be appreciated that the requesting party may be a client, or, alternatively, an agent of the client that operates the image displaying device 38.

Then, control of the session is transferred from the Access Control ASIC 18 to the one or more camera ASICs 26. Then, as described above, the user may request a particular video feed from a particular camera 36a-36n of the one or more cameras 36 by sending the request to the one or more Camera ASICs 26. Then, one of the Camera ASICs 26 sends the video feed to the image displaying device 38. If desired, the video feed may be sent to the image displaying device 38 with or without encryption.

The responsibility of the Camera ASIC 26 is to insure that the requested video reaches the image displaying device 38. In an embodiment, the Camera ASIC 36 determines the best path within the surveillance system 10 for sending the video to the image displaying device 38 (see, e.g., FIGS. 5A and 5B below). In an embodiment, the Camera ASIC 36 may also encrypt/encode the video feed.

In an embodiment, the initial request for the video feed at the image displaying device 38 may be responsive to an alarm notification. For example, the DAQ ASIC 24 or its complement may constantly monitor the Alarm ASIC 22, and, at some point, the DAQ ASIC 24 may receive notification that a potential security event has occurred such that the notification is subsequently communicated to the user in the form of, for example, an email, a text message, or a live/automated phone call or voicemail message. In an embodiment, the DAQ ASIC 24 determines the best path for providing the notification to the user (see, e.g., FIGS. 5A, 5B below). In an embodiment, once the Network ASIC 12 receives the notification (see, e.g., FIG. 5A), the Network ASIC 12 sends a communication to the provider 40 such that one or more of an email, text message, voicemail or phone call is placed to the user such that the user may request the video feed as described above.

D. Decentralized Operation

Each ASIC 12-26n may support/complement another ASIC 12-26n by utilizing identical or substantially identical circuits, host functions and/or firmware provided within the ASICs 12-26n. Further, to permit each ASIC 12-26n to support/complement another ASIC 12-26n in the surveillance system 10, each of the ASICs 12-26n may include, but is not limited to the following: (a) one or more microcontrollers, microprocessors or digital signal processor (DSP) cores, (b) memory blocks including a selection of read only memory (ROM), random access memory (RAM), electronically erasable programmable read only memory (EEPROM) and flash memory, (c) timing sources including oscillators and phase-locked loops, (d) peripherals including counter-timers, real-time timers and power-on reset generators, (e) external interfaces including industry standards such as universal serial bus (USB), FireWire, Ethernet, universal synchronous/asynchronous receiver/transmitter (USART) and serial peripheral interface (SPI), (f) analog interfaces including analog-to-digital converters (ADCs) and digital-to-analog converters (DACs), (g) voltage regulators and power management circuits, (h) Level 1 and/or Level 2 cache, (i) floating point coprocessors, (j) industry standard encoders such as MPEG-4 H.263/H.264 D1 HW codec, (k) Advanced Power Management systems, (l) ATA-6 (HDD) interfaces, and (m) integrated security/encryption interfaces.

Further, in an embodiment, functions of each ASIC 12-26n may be carried out by a system on a chip (SOC), or, alternatively, a feature-rich processor technology. For example, direct memory access (DMA) controllers route data directly between external interfaces and memory, by-passing the processor core and thereby increasing the data throughput.

Further, although each ASIC 12-26n has a microcontroller or microprocessor, it will be appreciated that no one ASIC 12-26n controls the entire surveillance system 10. In an embodiment, the surveillance system 10 functions like a mesh network.

Accordingly, in the event that one of the ASICs 12-26n fail at any given time, it will be appreciated that each of the ASICs 12-26n of the surveillance system 10 may support/complement the failed/inoperative ASIC 12-26n within the system. As such, the surveillance system 10 may be referred to as a “decentralized” surveillance system (DSS). Thus, a self-recovery feature is provided through the implementation of a plurality of ASICs 12-26n that are spread throughout the topography of the DSS 10 such that any one ASIC 12-26n may potentially back-up every other ASIC 12-26n in the DSS 10.

In a first example, it is perceivable that the Camera ASIC 26a, for example, may fail. Accordingly, rather than rendering the video captured by camera 36a unavailable due to the fact that the Camera ASIC 26a is connected to and is primarily responsible for sending the video feed to the image displaying device 38, a neighboring Camera ASIC, such as, for example, the camera ASIC 26b, may support functions for the failed camera ASIC 26a. Thus, the camera ASIC 26b may perform some or all of the functions that were to be conducted by the camera ASIC 26a such that the video captured by the camera 36a may be provided to the image displaying device 38.

Although the Camera ASICs 26a, 26b are shown directly connected to one another in FIG. 1 via a common node 28a, it will be appreciated that any one of the Camera ASICs 26a-26n may be connected to one another by way of the bus 28. For example, the Camera ASIC 26a may be “connected” to the Camera ASIC 26c although the Camera ASICs 26a, 26c do not physically share a common node 28a.

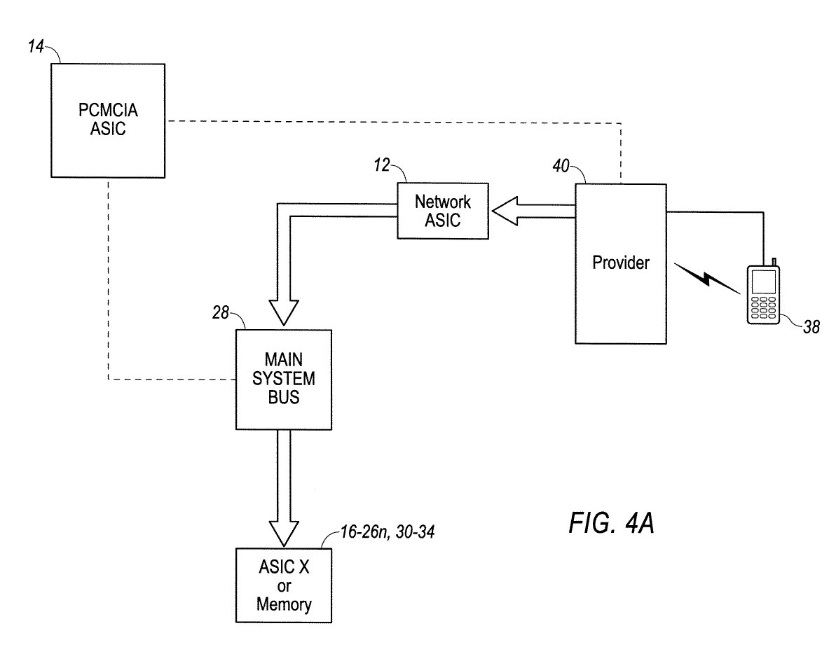

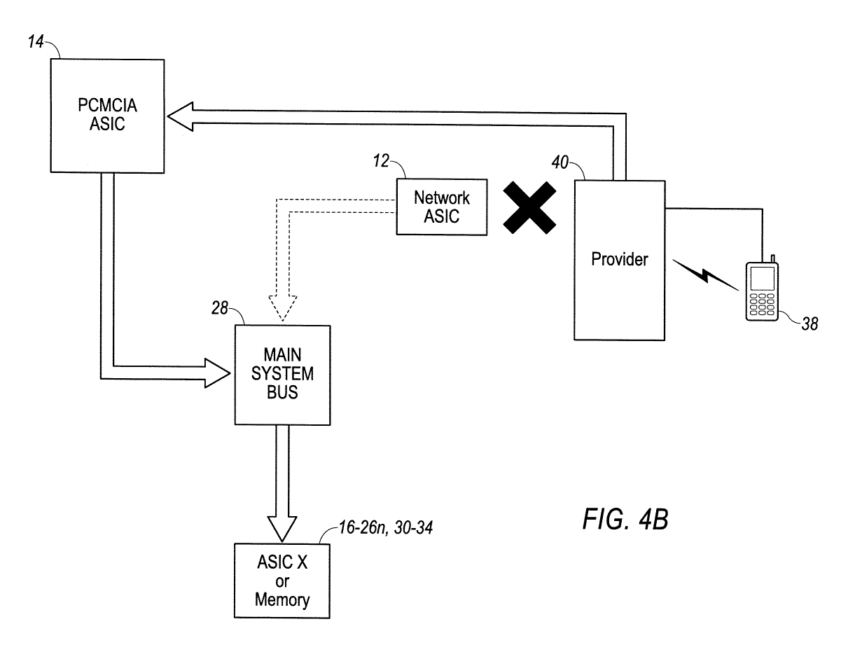

Referring now to FIGS. 4A and 4B, another exemplar operation of the DSS 10 is shown according to an embodiment. As seen in FIG. 4A, the user may attempt to establish a connection with the DSS 10 by way of the Network ASIC 12. As illustrated, the Network ASIC 12 interfaces with the provider 40 such that the Network ASIC 12 may communicate with other ASICs 16-26n or memory 30-34 by way of the bus 28. Although it is described that the user connects to the DSS 10 by way of the Network ASIC 12, it will be appreciated that this connection is transparent to the user.

However, as seen in FIG. 4B, if, for example, the Network ASIC 12 were to fail and is unavailable, the provider 40 may not be able to interface with the Network ASIC 12 as shown in FIG. 4A. Accordingly, the PCMCIA ASIC 14 may support the functionality of the Network ASIC 12 by interfacing with the provider 40. As illustrated, the PCMCIA ASIC 14 provides an alternate network path within the DSS 10 in the event the Network ASIC 12 fails, becomes physically disconnected or is unavailable for another reason. In an embodiment, the PCMCIA ASIC 14 may include, for example, a Universal Serial Bus (USB) connection to a network of the provider 40. As similarly stated above, although it is described that the user connects to the DSS 10 by way of the PCMCIA ASIC 14, it will be appreciated that this connection is transparent to the user.

Referring to FIGS. 5A and 5B, another exemplar operation of the DSS 10 is shown according to an embodiment. As seen in FIG. 5A, a video feed/communication/data from one or more of the ASICs 16-26n or memory 30-34 may be returned to the user. As illustrated, the bus 28 sends the video feed/communication/data to the Network ASIC 12 and out to the provider 40 that is interfaced with the Network ASIC 12.

However, as seen in FIG. 5B, if, for example, the Network ASIC 12 were to fail, the Network ASIC 12 may not be able to interface with the provider 40 as shown in FIG. 5A. Accordingly, the PCMCIA ASIC 14 may support the functionality of the Network ASIC 14 by interfacing with the provider 40 such that the bus 28 may re-route the video feed/communication/data from one or more of the ASICs 16-26n or memory 30-34 through the PCMCIA 14 and out to the provider 40 for receipt at the image displaying device 38.

The present invention has been described with reference to certain exemplary embodiments thereof. However, it will be readily apparent to those skilled in the art that it is possible to embody the invention in specific forms other than those of the exemplary embodiments described above. This may be done without departing from the spirit of the invention. The exemplary embodiments are merely illustrative and should not be considered restrictive in any way. The scope of the invention is defined by the appended claims and their equivalents, rather than by the preceding description.

What is claimed is:

1. A method for operating a security system, comprising the steps of:
providing a surveillance system including:
a plurality of application specific integrated circuits that communicate with one another over
a main system bus, wherein each of the plurality of application specific integrated circuits perform a function for operating the surveillance system;
decentralizing an arrangement of the plurality of application specific integrated circuits within the surveillance system;
determining that one or more of the application specific integrated circuits is not performing its function; and
utilizing one or more of the functioning application specific integrated circuits to perform the function of the non-functioning application specific integrated circuit.

2. The method according to claim 1, further comprising the steps of:
arranging one or more imaging devices in communication with one or more of the plurality of application specific integrated circuits;
capturing security information with the one or more imaging devices;
sending the captured security information through the surveillance system for receipt by one or more image displaying devices.

3. The method according to claim 2, further comprising the steps of:
determining that one or more of the non-functioning application specific integrated circuits is
a camera application specific integrated circuit in communication with
a first camera that captures the security information; and utilizing
a functioning camera application specific integrated circuit in communication with
a second camera to perform the function of the non-functioning camera application specific integrated circuit in communication with the first camera.

4. The method according to claim 1, wherein one or more of the application specific integrated circuits includes:
a network application specific integrated circuit,
a peripheral component micro-channel interconnect architecture application specific integrated circuit, and
a provider connected to both the network application specific integrated circuit and the peripheral component micro-channel interconnect architecture application specific integrated circuit, wherein the method further comprises the steps of
determining that the network application specific integrated circuit is not performing its function; and
utilizing the peripheral component micro-channel interconnect architecture application specific integrated circuit to perform the function of the non-functioning network application specific integrated circuit.

5. A security system, comprising:
a decentralized surveillance system including
a main system bus, and
a plurality of decentralized application specific integrated circuits that communicate with one another over the main system bus; and
one or more imaging devices that captures security information, wherein the one or more imaging devices communicate with one or more of the decentralized application specific integrated circuits of the decentralized surveillance system.

6. The security system according to claim 5, further comprising:
one or more image displaying devices that receives the captured security information from the decentralized surveillance system.

7. The security system according to claim 6, wherein the one or more image displaying devices includes a mobile device

8. The security system according to claim 7, wherein the mobile device includes:
a cell phone or personal digital assistant.

9. The security system according to claim 6, wherein the one or more image displaying devices includes a computer terminal.

10. The security system according to claim 6, further comprising:
a provider that communicates with one or more of the decentralized application specific integrated circuits, wherein the provider routes the captured security information to the one or more image displaying devices from the decentralized surveillance system.

11. The security system according to claim 10, wherein the provider is:
a phone or Internet service provider.

12. The security system according to claim 5, wherein the decentralized surveillance system further comprises:
one or more memory devices that communicate with one or more of the decentralized application specific integrated circuits.

13. The security system according to claim 5, further comprising:
one or more motion detectors that communicate with one or more of the application specific integrated circuits; and
one or more proximity sensors that communicate with one or more of the application specific integrated circuits.

14. A method for operating a security system comprising the steps of:
detecting a security event;
sending a notification of the security event to a client;
receiving the notification at the client;
requesting access to security information from the security system;
authenticating that the requesting party is the client, or, an agent of the client; and
permitting the requesting party access to the security system.

15. The method according to claim 14, wherein the sending step includes using a first application specific circuit to send a text message to the client.

16. The method according to claim 14, wherein the sending step includes using a first application specific circuit to send a phone message to the client.

17. The method according to claim 14, wherein prior to the detecting step, further comprising the step of:
communicating with one or more imaging devices; and
capturing one or more images of the premises with the one or more imaging devices.

18. The method according to claim 17, wherein the requesting step includes:
requesting access to the one or more images.

19. The method according to claim 18, wherein, subsequent to the permitting step;
sending the one or more images through one or more of a plurality of decentralized application specific integrated circuits of the surveillance system to a provider for receipt at one or more image displaying devices viewable by the client.
